(19) United States
(12) Patent Application Publication
(10) Pub. No.: US 2024/0314866 A1
(43) Pub. Date: Sep. 19, 2024

(54) ONLINE PAIRING METHOD AND COMPUTER-READABLE STORAGE MEDIUM

(71) Applicant: EZMira Microelectronics Co., Ltd., Guangzhou (CN)

(72) Inventors: Cheng Feng LI, Taoyuan City (TW); Jian Chang CHENG, New Taipei City (TW); Ying Jui LEE, Hsinchu City (TW)

(21) Appl. No.: 18/184,430

(22) Filed: Mar. 15, 2023

(51) Int. Cl. H04W 76/15; G06F 3/14; H04W 76/11

(52) U.S. Cl. CPC H04W 76/15; G06F 3/14; H04W 76/11; H04W 4/80

(57) ABSTRACT

An online pairing method and a computer-readable storage medium are proposed. The online pairing method may be applied to a signal source device and a display device. The signal source device may output a display signal to the display device for display. The method may include dual-channel connection, transmitter sending identity identification information, receiver entering pairing mode, transmitter entering pairing mode, receiver sending online information, and communication connection. Various embodiments can make online pairing and its usage easy, and can improve user experience.

### BACKGROUND

### Technical Field

The present disclosure relates to wireless projection, and in particular, to an online pairing method and a computer-readable storage medium.

### Description of Related Technology

As wireless projection systems become more and more widely used, it can be seen that wireless connection between a display device and a signal source device through a wireless projection system is an important function.

### SUMMARY

One aspect is an online pairing method and a computer-readable storage medium that are easy to pair and use and have good user experience.

Another aspect is an online pairing method, which is applied to a signal source device and a display device, wherein the signal source device outputs a display signal to the display device for display, and the method comprises the following steps:
dual-channel connection: connecting a transmitter with the signal source device, connecting a receiver with the display device, then connecting a first image channel of the transmitter with a second image channel of the receiver, simultaneously connecting a first identification data channel of the transmitter with a second identification data channel of the receiver, the first identification data channel is used to send identity identification information of the transmitter, and the second identification data channel is used to receive the identity identification information;
transmitter sending identity identification information: the transmitter sends the identity identification information through the first identification data channel;
receiver entering pairing mode: the receiver receives the identity identification information through the second identification data channel, configures its own working mode as pairing mode, generates a feature image with image identification information, and sends the feature image through the first image channel;
transmitter entering pairing mode: the transmitter receives the feature image through the first image channel, identifies the image identification information according to the feature image, and makes a judgment according to the image identification information, if the image identification information conforms to preset identification information, the working mode is configured as pairing mode;
receiver sending online information: the receiver sends online information through the first image channel;
communication connection: the transmitter receives the online information through the first image channel 31, and establishes a communication connection with the receiver according to the online information, where the communication connection is used to transmit the display signal output by the signal source device to the receiver through the transmitter, so as to send the received display signal to the display device for display via the receiver.

In some embodiments, both the first image channel and the second image channel are the same image connection device, and the image connection device includes any one of VGA, HDMI, DP, Type C, and Video formats.

In some embodiments, the first identification data channel and the second identification data channel are both I2C bus channels or DDC channels.

In some embodiments, the identity identification information is extended display identification data.

In some embodiments, the identity identification information is VSDB information or a monitor name of the extended display identification data.

In some embodiments, the image identification information is a preset resolution or a preset image of the feature image.

In some embodiments, the communication connection includes a WIFI connection, an Ethernet connection, and a Bluetooth connection.

The present disclosure further provides a computer-readable storage medium, where the computer-readable storage medium stores a computer program, the computer program includes a program instruction, and when the program instruction is executed by a processor, steps in the online pairing method are implemented.

Compared with the prior art, the present disclosure relates to an online pairing method and a computer readable storage medium, where the online pairing method comprises the following steps: dual-channel connection, transmitter sending identity identification information, receiver entering pairing mode, transmitter entering pairing mode, receiver sending online information, and communication connection. According to the method, a first image channel of the transmitter is connected to a second image channel of the receiver, simultaneously, a first identification data channel of the transmitter is connected to a second identification data channel of the receiver, the first identification data channel sends the identity identification information, the receiver receives the identity identification information and enters pairing mode, the receiver sends a feature image through the first image channel, the transmitter identifies image identification information from the feature image, makes a judgment according to the image identification information, if the image identification information conforms to preset identification information, the transmitter enters pairing mode and receives the online information sent by the receiver, and the transmitter establishes communication connection with the receiver according to the online information. The above steps complete online pairing automatically, the process does not additionally require the adoption of pre-pairing with USB, nor does it require additional pre-installation of an application program or a driver program, and the pairing process is realized automatically, so that the connection of online pairing is easy to match and use, and the user experience is good.

### BRIEF DESCRIPTION OF THE DRAWINGS

In order to illustrate the technical means in the embodiments of the present disclosure more clearly, the accompanying drawings that need to be used in the description of the embodiments are briefly described below. It is obvious that the accompanying drawings in the following description are merely some embodiments of the present disclosure, and those skilled in the art may obtain other drawings according to these drawings without involving creative effort.

FIG. 1 is a flow chart of an online pairing method of the present disclosure.

FIG. 2 is a connection relationship diagram of related devices of an online pairing method of the present disclosure.

### DETAILED DESCRIPTION

The wireless projection system of the relevant art comprises a transmitter and a receiver, wherein the transmitter is connected to the signal source device, and the receiver is connected to the display device. The signal source device sends a display signal generated by the signal source device to the display device through the transmitter and the receiver sequentially, and the display device receives the display signal and displays the display signal.

However, the current transmitter and receiver require pre-installation of an application program or a driver program for wireless connection and require pre-pairing to establish a wireless connection so as to realize projection. There is a need for additional hardware, such as a button or a USB interface when pairing. Wherein, the pre-pairing generally adopts USB pairing, and specifically, the transmitter and the receiver are paired in series through a USB or a USB portable disk is used to store a pairing file, and then pairing is performed respectively. The pairing manner causes the need of a USB serial connection in each of the transmitters and each of the receivers for pairing. Meanwhile, it causes operation complexity during use and the user experience is poor.

Therefore, it is necessary to provide a new method to solve the above technical problem.

The technical means in the embodiments of the present disclosure will be clearly and completely described below in conjunction with the accompanying drawings in the embodiments of the present disclosure, and it is clear that the described embodiments are only some, not all, embodiments of the present disclosure. All other embodiments obtained by a person of ordinary skill in the art based on the embodiments of the present disclosure without creative efforts shall fall within the scope of protection of the present disclosure.

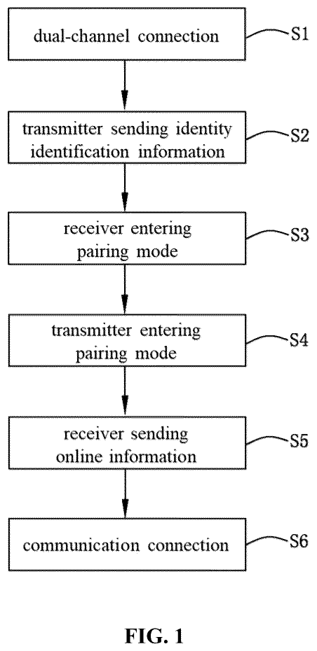

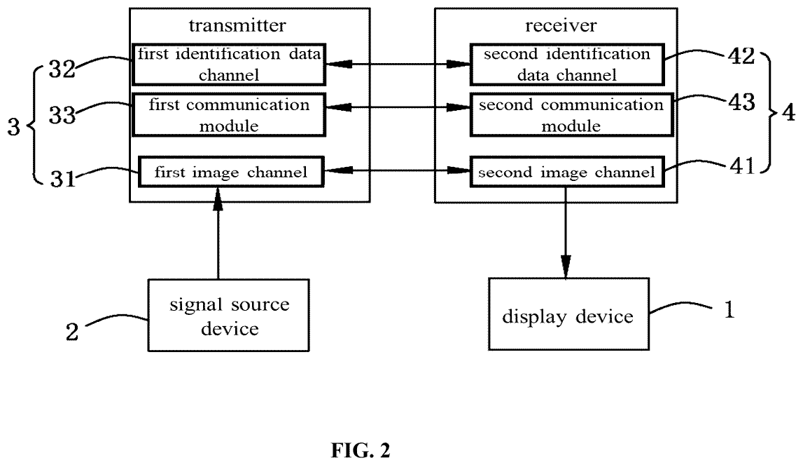

Referring to FIG. 1 and FIG. 2, the present disclosure provides an online pairing method. The online pairing method is applied to a display device 1 and a signal source device 2, and the signal source device 2 outputs a display signal to the display device 1 for display.

In order to enable the display device 1 and the signal source device 2 to implement a wireless screen projection function, the online pairing method implements a communication connection by providing a transmitter 3 and a receiver 4 that can transmit wireless data to each other. Wherein, the communication connection is a wireless connection.

In this embodiment, the communication connection includes a WIFI connection, an Ethernet connection, and a Bluetooth connection.

It should be noted that the display device 1, the signal source device 2, the transmitter 3, and the receiver 4 are all common devices, modules, or components in the art. A designer selects a related model according to actual needs, which is not described in detail herein.

The transmitter 3 includes a first image channel 31, a first identification data channel 32, and a first communication module 33.

The first image channel 31 is in data connection with the signal source device 2. The first image channel 31 is used to receive the display signal output by the signal source device 2.

The first identification data channel 32 is used to send data to the receiver 4.

The first communication module 33 is used to be in communication connection with the second communication module 43.

The receiver 4 includes a second image channel 41, a second identification data channel 42, and a second communication module 43.

The second image channel 41 is in data connection with the display device 1 and can be in data connection with the first image channel 31. The second image channel 41 is used to output an image to the display device 1.

The second identification data channel 42 is used to receive data sent by the first identification data channel 32.

The second communication module 43 is used to be in communication connection with the first communication module 33.

It should be noted that the first image channel 31, the first identification data channel 32, the first communication module 33, the second image channel 41, the second identification data channel 42, and the second communication module 43 are all common modules or components in the art. A designer selects a related model according to actual needs, which is not described in detail herein.

In this embodiment, both the first image channel 31 and the second image channel 41 are the same image connection device, and the image connection device includes any one of VGA, HDMI, DP, Type C, and Video formats. Certainly, it is not limited thereto, and it is also possible that the first image channel 31 and the second image channel 41 are respectively different image connection devices, specifically selected according to actual needs.

In this embodiment, the first identification data channel 32 and the second identification data channel 42 are both I2C bus channels or DDC channels. DDC is short for Direct Digital Control.

The online pairing method comprises the following steps:
Step S1, dual-channel connection, connecting the transmitter 3 with the signal source device 2, connecting the receiver 4 with the display device 1, then connecting the first image channel 31 of the transmitter 3 with the second image channel 41 of the receiver 4, and simultaneously connecting the first identification data channel 32 of the transmitter 3 with the second identification data channel 42 of the receiver 4.

The first identification data channel 32 is used to send identity identification information of the transmitter 3, and the second identification data channel 42 is used to receive the identity identification information.

Wherein the first image channel 31 and the first identification data channel 32 are both existing module components of the transmitter 3. The second image channel 41 and the second identification data channel 42 are both existing module components of the receiver 4. The operation of step S1 does not require additionally added module component such as a USB, a button, or the like, and does not require additional pre-installation of an application program or a driver program, so that the user experience of the online pairing method is good.

The identity identification information is Extended Display Identification Data (EDID for short). EDID is a standard related to display identification data formulated when the VESA formulates a DDC display data channel communication protocol. The EDID is stored in a DDC memory in a display, and after a host computer is connected to the display, the host computer would read the EDID stored in the DDC memory of the display through the DDC channel.

In this embodiment, the identity identification information is VSDB information (VSDB is short for Vendor Specific Data Block) or a monitor name of the extended display identification data.

Step S2, transmitter sending identity identification information, the transmitter 3 sends the identity identification information through the first identification data channel 32.

Step S3, receiver entering pairing mode, the receiver 4 receives the identity identification information through the second identification data channel 42, configures its own working mode as pairing mode, generates a feature image with image identification information, and sends the feature image through the first image channel 31.

In this embodiment, the image identification information is a preset resolution or a preset image of the feature image. The preset image inserts special information into the feature image, for example, a watermark, a shape, a color combination, or the like.

Step S4, transmitter entering pairing mode, the transmitter 3 receives the feature image through the first image channel 31, identifies the image identification information according to the feature image, and makes a judgment according to the image identification information, if the image identification information conforms to the preset identification information, the working mode is configured as pairing mode.

The setup of the feature image is beneficial to enable the transmitter 3 to enter pairing mode easily, and no additional hardware needs to be added.

Step S5, receiver sending online information, the receiver 4 sends online information through the first image channel 31.

The online information may enable the first communication module 33 and the second communication module 43 to implement a communication connection.

Step S6, communication connection, the transmitter 3 receives the online information through the first image channel 31, and establishes a communication connection with the receiver according to the online information, where the communication connection is used to transmit the display signal output by the signal source device 2 to the receiver 4 through the transmitter 3, so as to send the received display signal to the display device 1 for display via the receiver 4.

According to the above steps of the online pairing method, online pairing of the transmitter 3 and the receiver 4 can be automatically completed. The process does not additionally require the adoption of pre-pairing with an USB, nor does it require additional pre-installation of an application program or a driver program. The pairing process is realized automatically, so that the connection of online pairing is easy to match and use, and the user experience is good.

The present disclosure further provides a computer-readable storage medium, where the computer-readable storage medium stores a computer program, the computer program includes a program instruction, and when the program instruction is executed by a processor, steps in the online pairing method are implemented.

Compared with the prior art, the present disclosure relates to an online pairing method and a computer readable storage medium, where the online pairing method comprises the following steps: dual-channel connection, transmitter sending identity identification information, receiver entering pairing mode, transmitter entering pairing mode, receiver sending online information, and communication connection. According to the method, a first image channel of the transmitter is connected to a second image channel of the receiver, and simultaneously, a first identification data channel of the transmitter is connected to a second identification data channel of the receiver, the first identification data channel sends the identity identification information, the receiver receives the identity identification information and enters pairing mode, the receiver sends a feature image through the first image channel, the transmitter identifies image identification information from the feature image, makes a judgment according to the image identification information, if the image identification information conforms to preset identification information, the transmitter enters pairing mode and receives the online information sent by the receiver, and the transmitter establishes communication connection with the receiver according to the online information. The above steps complete online pairing automatically. The process does not additionally require the adoption of pre-pairing with an USB, nor does it require additional pre-installation of an application program or a driver program, and the pairing process is realized automatically, so that the connection of online pairing is easy to match and use, and the user experience is good.

The foregoing are merely embodiments of the present disclosure, and it should be noted that, for a person of ordinary skill in the art, improvements may be made without departing from the concept of the present disclosure, but these are all within the scope of protection of the present disclosure.

What is claimed is:

1. An online pairing method, applied to a signal source device and a display device, where the signal source device outputs a display signal to the display device for display, the method comprising:
an operation of dual-channel connection comprising: connecting a transmitter with the signal source device, connecting a receiver with the display device, then connecting a first image channel of the transmitter with a second image channel of the receiver, simultaneously connecting a first identification data channel of the transmitter with a second identification data channel of the receiver, the first identification data channel is used to send identity identification information of the transmitter, and the second identification data channel is used to receive the identity identification information;
an operation of transmitter sending identity identification information in which the transmitter sends the identity identification information through the first identification data channel;
an operation of receiver entering pairing mode in which the receiver receives the identity identification information through the second identification data channel, configures its own working mode as pairing mode, generates a feature image with image identification information, and sends the feature image through the first image channel;
an operation of transmitter entering pairing mode in which the transmitter receives the feature image through the first image channel, identifies the image identification information according to the feature image, and makes a judgment according to the image identification information, if the image identification information conforms to preset identification information, the working mode is configured as pairing mode;
an operation of receiver sending online information in which the receiver sends online information through the first image channel; and
an operation of communication connection in which the transmitter receives the online information through the first image channel 31, and establishes a communication connection with the receiver according to the online information, where the communication connection is used to transmit the display signal output by the signal source device to the receiver through the transmitter, so as to send the received display signal to the display device for display via the receiver.

2. The online pairing method according to claim 1, wherein both the first image channel and the second image channel are the same image connection device, and the image connection device includes any one of VGA, HDMI, DP, Type C, or video formats.

3. The online pairing method according to claim 1, wherein the first identification data channel and the second identification data channel comprise both I2C bus channels or DDC channels.

4. The online pairing method according to claim 1, wherein the identity identification information comprises extended display identification data.

5. The online pairing method according to claim 4, wherein the identity identification information comprises VSDB information or a monitor name of the extended display identification data.

6. The online pairing method according to claim 1, wherein the image identification information comprises a preset resolution or a preset image of the feature image.

7. The online pairing method according to claim 1, wherein the communication connection comprises a WIFI connection, an Ethernet connection, and a Bluetooth connection.

8. A non-transitory computer-readable storage medium storing instructions, when executed by one or more processors, configured to perform the method of claim 1.

9. The medium according to claim 8, wherein both the first image channel and the second image channel are the same image connection device, and the image connection device includes any one of VGA, HDMI, DP, Type C, or video formats.

10. The medium according to claim 8, wherein the first identification data channel and the second identification data channel comprise both I2C bus channels or DDC channels.

11. The medium according to claim 8, wherein the identity identification information comprises extended display identification data.

12. The medium according to claim 11, wherein the identity identification information comprises VSDB information or a monitor name of the extended display identification data.

13. The medium according to claim 8, wherein the image identification information comprises a preset resolution or a preset image of the feature image.

14. The medium according to claim 8, wherein the communication connection comprises a WIFI connection, an Ethernet connection, and a Bluetooth connection.
